(19) United States
(12) Patent Application Publication
(10) Pub. No.: US 2011/0001828 A1
(43) Pub. Date: Jan. 6, 2011

(54) METHOD FOR CONTROLLING AN ALARAM MANAGEMENT SYSTEM

(75) Inventor: Maurizio Bigoloni, Milano (IT)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/918,891

(22) PCT Filed: Oct. 27, 2008
(86) PCT No.: PCT/EP2008/009057

§ 371 Date: Aug. 23, 2010

(30) Foreign Application Priority Data
Feb. 21, 2008 (EP) 08003152.9

(51) Int. Cl. H04N 7/18

(52) U.S. Cl. 348/159; 348/E07.085

(57) ABSTRACT

Method for an alarm management system installed on a site, whereby the controlling comprises a specification of an architecture of a site and setting of parameters as well as commanding cameras in order to transfer images or live video to a management station comprised in the alarm management system, comprising the steps of creating a map of a surveillance area of the site based on site architecture data, the map further comprising at least one detection object as well as a position and a coverage area of at least one installed camera, specifying an association of the detection object to the installed camera, storing a totality of associations of a totality of detection objects in a database, looking up the database in order to identify the installed camera associated with the detection object, positioning the installed camera such that it captures one of: images of an area where the detection object is located, live video of the area where the detection object is located, triggering a transmission from the installed camera to the management station of one of: the images, the live video.

The invention relates to a method for controlling an alarm management system, especially by commanding a Pan Tilt Zoom camera (PTZ camera).

One important aspect in the field of building technologies is a reliable and fast detection of events occurring in various parts of a site. The events differ in their cause and importance and are detected by a variety of sensors and devices, each type of sensor being designed for a special event type. Examples of events are: fire, smoke, intrusion, water leak. Therefore a variety of types of detector objects exist, like fire detectors, motion detectors, etc. A wide-spread solution to monitor the events is by installing cameras throughout the site, such that especially sensitive environments, like high-security access points, can be surveyed. Data, like still images or live video transmitted from the cameras are collected into a central surveillance entity like a management station, where they are monitored in real time and recorded for backup purposes. A problem related to this solution is the complexity of such systems, especially systems covering large sites, thus requiring a high amount of cameras and detection objects. All surveyed areas can hardly be monitored at once, thus, in many cases, views of the surveyed areas are showed sequentially on monitoring means. This fact introduces delays between subsequent views of a same surveyed area resulting in a late reaction to an event which occurred in that area. PTZ units are used to focus a PTZ camera to a desired object. Pan means rotating the camera around the Z-axis. Tilt means rotating the camera around the X-axis. Zoom means Y axis movement of a motorized optical lens comprised in the camera.

One goal to be achieved is to provide a system which monitors the surveyed areas in an intelligent way, allowing a fast tracking of the events and their location.

One way the goal is achieved is in providing a method for controlling an alarm management system installed on a site, whereby the controlling comprises a specification of an architecture of a site and setting of parameters as well as commanding cameras in order to transfer images or live video to a management station comprised in the alarm management system, comprising the steps of:
a) creating a map of a surveillance area of the site based on a site architecture, the map further comprising at least one detection object as well as a position and a coverage area of at least one installed camera,
b) specifying an association of the detection object to the installed camera, the association being based on a location of the detection object within the coverage area of the installed camera,
c) storing a totality of associations of a totality of detection objects in a database,
d) looking up the database in order to identify the installed camera associated with the detection object, whereby the detection object has previously signalled an event to the alarm management system,
e) positioning the installed camera such that it captures one of: images of an area where the detection object is located, live video of the area where the detection object is located,
f) triggering a transmission from the installed camera to the management station of one of: the images, the live video.

Features and advantages of the present invention will become more apparent from the following detailed description in conjunction with the following figures and example, whereby:

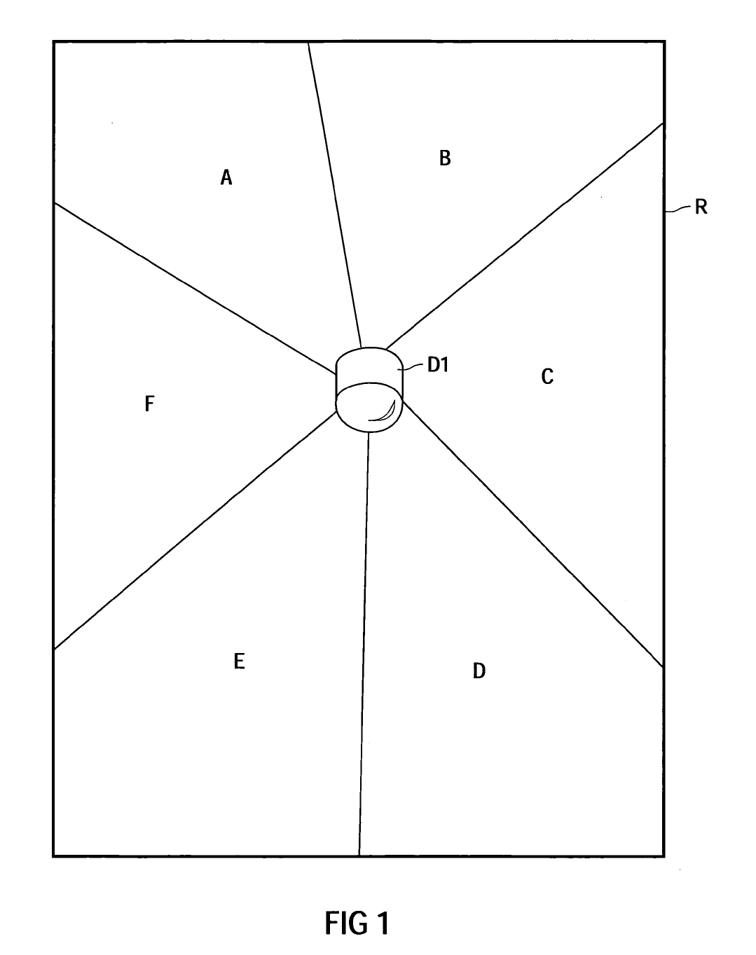

FIG. 1: Example of a hall region division for an installed PTZ camera

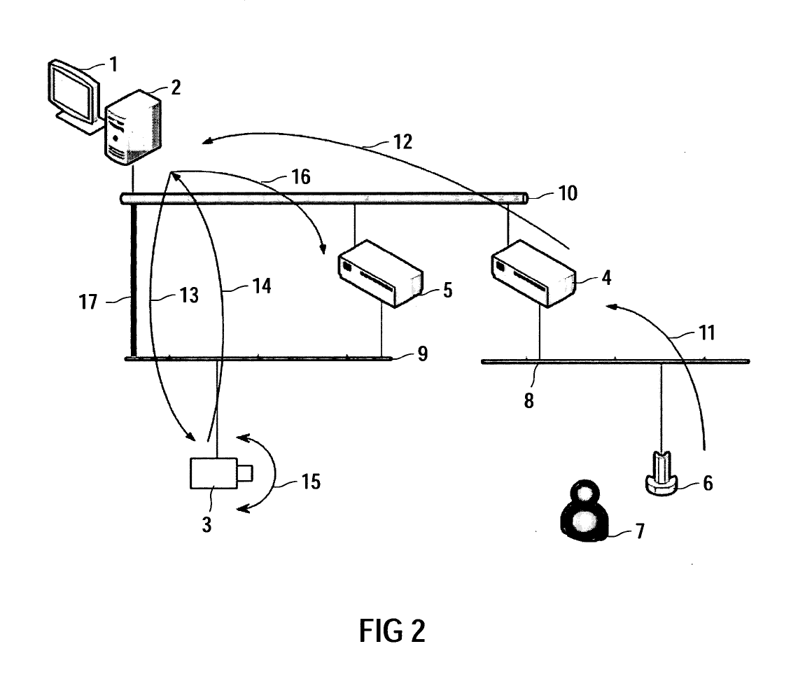

FIG. 2: Example of an event detection in an alarm management system

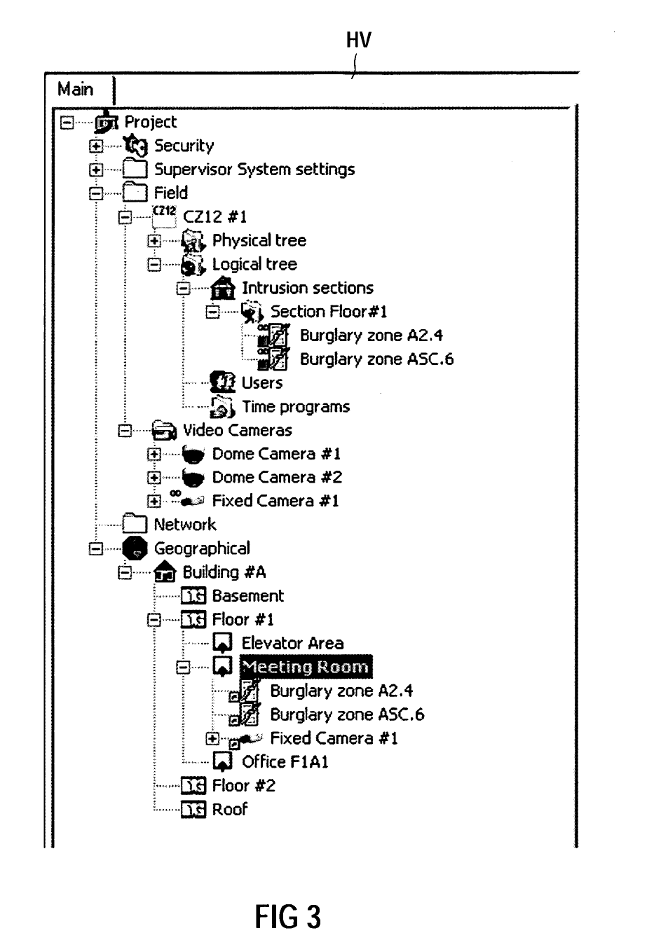

FIG. 3: Example of objects to be inserted into a map of a surveillance area

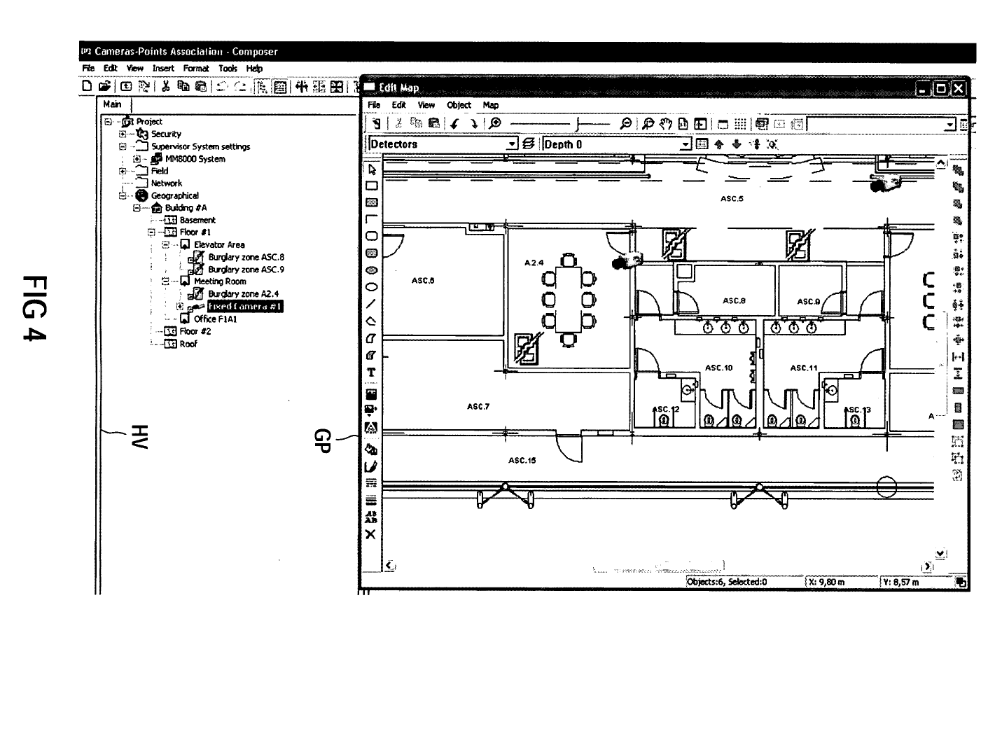

FIG. 4: Example of a map of a surveillance area created with a computer aided design software tool

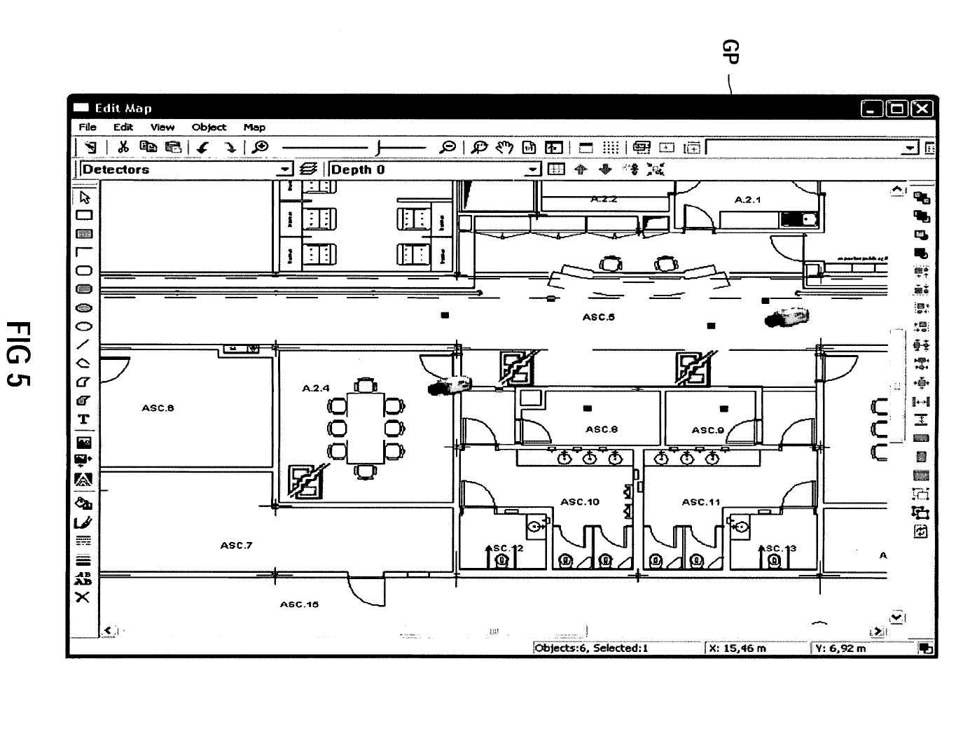

FIG. 5: Example of defining a camera position and coverage area using the computer aided design software tool

FIG. 1 shows an example of a hall R region division for an installed PTZ camera D1, whereby the coverage area of the camera is divided into six regions, each region corresponding to a unique orientation of the camera, the orientation being defined by a pan position, a tilt position and a zoom factor. In this example the six regions are:
A=Entrance northwest
B=Entrance northeast
C=Conference room door
D=not defined
E=Meeting room door
F=Hall west

FIG. 2 shows an example of an event detection in an alarm management system. The alarm management system in this example comprises a monitor 1 connected to a management station 2. The management station 2 is further connected via a first data bus system 10 to a digital video recorder 5 and an intrusion controller 4. A second data bus system 9 connects an installed PTZ camera 3 to the digital video recorder 5. The second data bus system is further connected to the first data bus system 10 via a communication line 17. The intrusion controller 4 is further connected to a detection object 6 via a third data bus system 8. It is assumed that the detection object 6 detects an intrusion of a person 7 and sends 11 an alarm signal to the intrusion controller 4. The alarm signal is further transmitted 12 by the intrusion controller 4 via the first data bus system 10 to the management station 2, which alerts a security officer via the monitor 1. The management station 2 looks in a database, not shown in this example, for an association between a position of the detection object 6 and an installed camera whose coverage area contains the position of the detection object, in this example the installed PTZ camera 3. Once the camera 3 is identified, the management station 2 sends 13 control commands to the camera 3 via the communication line 17 to move 15 the camera 3 in an appropriate position such that the area of intrusion of the person 7 is entirely captured. Furthermore, the management station 2 triggers capturing a continuous live video by the camera 3, which is sent 14 via the communication line 17 to the management station 2 and displayed to the security officer on the monitor 1. In a further step, the management station 2 instructs 16 the digital video recorder 5 to record the live video. A recording of the live video is done either by forwarding the live video from the management station 2 to the digital video recorder 5 via the first data bus system 10 or by direct recording the live video via the second data bus system 9.

FIG. 3 shows an example of objects to be inserted into a map of a surveillance area. In this example a hierarchical view HV is used to make available the objects. The hierarchical view HV is a part of a computer aided design software tool used to create the map of the surveillance area, which will be further explained in FIG. 4. The hierarchical view HV contains physical objects such as detection objects and cameras. Furthermore, it contains geographical objects such as buildings, floors, rooms, etc. Both the physical and the geographical objects are ready to be inserted, for example by drag and drop operations, into a graphical page containing the map of the surveillance area.

FIG. 4 shows an example of the map of the surveillance area created with the computer aided design software tool. The hierarchical view HV described in FIG. 3 is located on the left hand side whereas a graphical page GP containing the map of the surveillance area is located on the right hand side. The graphical page GP contains a plurality of rooms and halls with a first camera installed in A.2.4 and a second camera installed in ASC.5. The map can be either created by dragging one of the geographical objects from hierarchical view HV onto the graphical page GP or by constructing it using graphical tools located on vertical bars situated left and right in the graphical page GP.

FIG. 5 shows an example of defining a camera position and coverage area using the computer aided design software tool. After the map has been created like described above, the coverage area for each of the installed cameras is defined. In this example, the coverage area for the second camera is set by defining a polygon, here shown as the grey surface in ASC.5. The polygon is shaped by dragging the small black squares into a desired position. The software tool creates an association between every point within the coverage area and the related camera and stores it in a database. In the following the term camera is used for a PTZ camera. The description herein is equally valid for a fix camera, additional information about pan position, tilt position and zoom factor is left out in the association.

Step a) of claim 1 of the present invention as described in FIGS. 3 and 4 advantageously enables the method to be used for arbitrary site architectures. By using a Document/View structure, being a window structure defined by Microsoft®, the software tool makes it possible to easily append multiple graphical pages GP to a project. Equally, the hierarchical view HV offers the possibility to append various types of the geographical objects and the physical objects which then can be inserted into the graphical page GP.

Step b) of claim 1 is described in FIG. 5. An advantage of using a user interactive definition of the coverage area of the installed camera is the possibility to adapt to various camera types with different features like different view angles, different zoom capabilities, etc. Furthermore, changes in room architecture can easily be updated into an existing map.

In step c) of claim 1 a connection between location of detection objects and related cameras is established. The main advantage is that this step enables an easy matching and locating of the detection objects based on already stored information. Furthermore, the software tool takes away a burden of inputting data for the association manually from the user, by computing the association for each point contained in the coverage area of the installed camera and saving results without user interaction.

Step d) of claim 1 takes advantage of associations already stored in the database to instruct the alarm management system how to react in case an event has been signaled by the detection object, reaction which is described in step e) whereby the alarm management system positions the camera, based on provided database information, such that the event signaled by the detection object is optimally captured.

Thereby it is possible to capture still images as well as live video.

As soon as the camera has been positioned, the alarm management system triggers in step f) of claim 1 transmission and recording of the still images or the live video.

The main advantage of the described method is that it provides an effective way of controlling the alarm management system by providing an all-in-one solution starting with a designing of the maps for desired site constellations up to actively using associations previously specified in the map in order to react upon a signaled event in an implemented alarm management system.

According to a preferred method, a computer aided design software tool is used to create the map, to add the detection object and to define the position and the coverage area of the installed camera.

According to another preferred method, the computer aided design software tool imports site architecture data from original planning data of the site. Other than the mentioned possibility of drawing a map using the graphical tools supplied within the software tool, it is also possible to import data already created at the time of planning and/or construction of the site from software suites used in architecture companies, like for example the software suite AutoCAD®. This is advantageous in that time for drawing the map is saved and accurate, scaled map information is available within the planning data.

The association of the detection object to the installed camera is specified by assigning coordinates of a spatial point of location of the detection object to a tuples comprising at least one of: a unique detection object identification tag, a unique camera identification tag, a camera type of the installed camera, further comprising optional information being at least one of: a fix position, a pan position, a tilt position, a zoom factor. One possibility of assigning the coordinates to the tuples is by creating and storing in the database multidimensional arrays which are referenced and/or searched for by an entry index. The unique detection object identification tag is used as the entry index. It identifies at the same time each detection object placed on the site and is transmitted to the management station every time a detection of an event occurs. Upon event reporting the database is searched for the entry index in order to find other information associated with it. The unique camera identification tag is used to identify a particular camera associated with the detection object which reported the event. The camera type is used to identify if the camera associated with the detection object is a PTZ camera or a fixed camera. In case the camera is a PTZ camera, the array may contain pan position, tilt position and/or zoom factor which are used to position the PTZ camera optimally for a recording of an area portion where the detection object is located.

In more detail, the coverage area is divided into regions, each region being defined by the pan position, the tilt position and the zoom factor of the installed camera. This information is applied in case the camera type is present. In an example of a large coverage area, several detection objects may be present at different locations within the large coverage area. In order to reach an optimum visualization of details around a particular detection object, the PTZ camera has to be moved into a particular direction and a zoom may be necessary, whereby this information is stored for each detection object separately. This makes the event detection more flexible and adjustable for complex architectures.

According to a preferred method, the event signalled by the detection object to the alarm management system is recognized to be of one of the types: fire/smoke, area access, motion, intrusion. The intrusion controller as described in FIG. 2 contains information about type of all detection objects associated with it and passes this information on to the management station. This makes it possible for the surveillance officer to have information about the type of event before even receiving a live video or still images of the event, thus allowing a first evaluation of for example gravity of the event.

As soon as the camera associated with the detection object has been identified and the camera has been set on recording mode, a recording of still images and/or live video received from the camera is triggered by the alarm management system. The management station comprised in the alarm management system is adapted to trigger a recording of incoming video/image data without user interaction, such that all recorded data is saved in first place, being useful for subsequent identification of persons, analysis of the event, etc.

### LIST OF ABBREVIATIONS

A=Entrance northwest
B=Entrance northeast
C=Conference room door
D=not defined
E=Meeting room door
F=Hall west
D1=PTZ camera
R=Hall
1=Monitor
2=Management Station
3=PTZ Camera
4=Intrusion Controller
5=Video Recorder
6=Detection Object
7=Person
8=Third Data Bus System
9=Second Data Bus System
10=First Data Bus System
11=Send alarm signal to intrusion controller
12=Transmit alarm signal to management station
13=Send control commands to the camera
14=Send live video to the management station
15=Move the camera
16=Instruct the digital video recorder to record the live video
17=Communication Line
HV=Hierarchical View
GP=Graphical Page

1-7. (canceled)

8. A method of controlling an alarm management system installed at a site, the control including a specification of an architecture of the site, settable parameters and commanding cameras in order to transfer images or live video to a management station forming a part of the alarm management system, the method which comprises:
a) creating a map of a surveillance area of the site based on site architecture data, the map further including at least one detection object as well as a position and a coverage area of at least one installed camera;
b) specifying an association of the detection object to the installed camera, the association being based on a location of the detection object within the coverage area of the installed camera;
c) storing a totality of associations of a totality of detection objects with a totality of installed cameras in a database;
d) looking up the database in order to identify the installed camera associated with the detection object, where the detection object has previously signaled an event to the alarm management system;
e) positioning the installed camera such that the camera captures images or live video of the area where the detection object is located; and
f) triggering a transmission from the installed camera to the management station of the images or the live video.

9. The method according to claim 8, which comprises using a computer aided design software tool to create the map, to add the detection object, and to define the position and the coverage area of the installed camera.

10. The method according to claim 9, whereing the computer aided design software tool imports the site architecture data from original planning data of the site.

11. The method according to claim 8, which comprises specifying the association of the detection object to the installed camera by assigning coordinates of a spatial point of location of the detection object to a tuples comprising at least one of: a unique detection object identification tag, a unique camera identification tag, a camera type of the installed camera.

12. The method according to claim 11, which further comprises specifying additional information selected from the group consisting of a fix position, a pan position, a tilt position, and a zoom factor of the installed camera.

13. The method according to claim 11, which comprises dividing the coverage area into regions, each region being defined by the pan position, the tilt position and the zoom factor of the installed camera.

14. The method according to claim 8, wherein the event signaled by the detection object to the alarm management system is recognized to be of one of the types: fire/smoke, area access, motion, intrusion.

15. The method according to claim 8, which comprises triggering with the alarm management system a recording of still images and/or live video received from the installed camera.
